(19) United States
(12) Patent Application Publication
(10) Pub. No.: US 2026/0146578 A1
(43) Pub. Date: May 28, 2026

(54) FUEL SYSTEM WITH DIRECT AND HIGH PRESSURE PORT FUEL INJECTION WITH THERMAL MANAGEMENT

(71) Applicant: Stanadyne Operating Company LLC, Jacksonville, NC (US)

(72) Inventors: Srinu Gunturu, Lexington, SC (US); Michael Hornby, Emerald Isle, NC (US)

(21) Appl. No.: 19/400,648

(22) Filed: Nov. 25, 2025

Related U.S. Application Data
(60) Provisional application No. 63/725,811, filed on Nov. 27, 2024.

(51) Int. Cl. F02M 63/02; F02D 41/38; F02M 55/02

(52) U.S. Cl. CPC F02M 63/023; F02D 41/3845; F02M 55/025; F02D 2250/31

(57) ABSTRACT

A fuel system for delivering liquid fuel to a combustion chamber of an internal combustion engine includes a port fuel injector in an air intake communicating with the combustion chamber, a first fuel rail containing pressurized liquid fuel in communication with the port fuel injector, a direct fuel injector arranged to inject fuel directly into the combustion chamber, second fuel rail containing pressurized liquid fuel in communication with the direct injector, a high-pressure fuel pump having a high-pressure outlet in communication with the second fuel rail, a regulator valve in communication with the high-pressure outlet and the first fuel rail, the regulator valve controllable to reduce a fuel pressure of fuel delivered to the first fuel rail relative to a fuel pressure at said high-pressure outlet; and a control system configured with computer-readable instructions executable to monitor fuel pressure in the first fuel rail, and control the regulator valve to deliver fuel to the first fuel rail to maintain a predetermined quantity of fuel at said predetermined pressure in the first fuel rail.

### FIELD

The present description relates generally to methods and systems for controlling a dual fuel injection system coupled to an internal combustion engine.

### BACKGROUND

Internal combustion engines may be configured with various fuel systems for delivering a desired amount of fuel to a combustion chamber. Example fuel systems may include port fuel injectors for delivering fuel into an intake port upstream of a combustion chamber, and direct fuel injectors for delivering fuel directly into the combustion chamber. Still other engines may be configured with a dual injection system that includes a port fuel injector and a direct fuel injector for each engine cylinder. The different fuel injection systems provide different advantages. For example, port fuel injectors may be operated to improve fuel vaporization, reduce engine emissions, and to reduce pumping losses at low loads. As another example, direct fuel injectors may be operated to improve engine performance and fuel consumption at higher loads. Dual fuel injection systems are able to leverage the advantages of both types of fuel delivery.

Port fuel injectors (PFI) are typically operated at a low pressure generated by a low-pressure pump (LPP) located in or near the fuel tank. Typical LPPs generate fuel pressures between 5 and 15 bar. In some dual fuel injection systems, part of the fuel from the LPP is delivered to the PFI system, while the remainder is delivered to a high-pressure pump (HPP) capable of pressurizing fuel to 350 bar or more. Highly pressurized fuel is delivered to a rail for distribution to direct injectors (DI) arranged to deliver fuel directly to the combustion chamber of each engine cylinder. Port fuel injectors operated at low pressure do not atomize liquid fuel as finely as DIs receiving highly pressurized fuel, so the liquid fuel takes longer to transition to vapor. Low temperatures prevalent in winter in some climates also adversely impact the ability of PFIs operating at low pressure to effectively vaporize liquid fuel, leading to cold starting issues and poor emissions at low temperatures.

It is known to heat the tips of PFIs to improve fuel vaporization at low temperatures. However, heating the tips of PFIs is expensive and is of only limited effectiveness. Heating fuel in the PFI fuel rail is also a possibility, but heated fuel a low pressure tends to vaporize in the rail and fuel lines leading to the PFIs and can result in vapor lock at the PFIs. Vapor pressure or equilibrium vapor pressure is the pressure of a vapor in thermodynamic equilibrium with its condensed phases in a closed container. When a liquid is in a confined, closed, container such as a fuel rail, fuel line, or fuel injector, an equilibrium exists between the liquid and its gaseous phase. This equilibrium exists regardless of the temperature inside the container and the temperature of the liquid. The equilibrium exists due to the fact that some of the particles in the liquid, essentially at any temperature, will always have enough energy to escape the intrinsic cohesive forces and enter the gaseous phase. There is a tendency for liquid fuels such as gasoline to “boil” into a vapor phase in a low-pressure PFI fuel rail, fuel line and/or fuel injector, causing vapor lock and inconsistent fuel flow. Because the boiling point of a liquid increases with pressure, elevating the pressure within a PFI system can reduce or eliminate the presence of vapor phase fuel, even at elevated temperatures.

There is a need for a fuel system that cost-effectively improves the performance of PFIs at low temperatures.

There is a need for a fuel system that cost-effectively adds PFI to a DI fuel system to improve performance and emissions.

### SUMMARY OF THE INVENTION

A disclosed fuel system employs a regulator valve connected to a high-pressure outlet of a HPP DI fuel pump to provide relatively high-pressure fuel of 50bar to a PFI system. The regulator valve eliminates the need for a separate fuel pump to supply fuel to the PFI system at pressures greater than can be produced by the LPP. The regulator valve may be controlled by an engine control unit (ECU) using pulse width modulation (PWM). Increasing the operating pressure of a PFI system will reduce fuel vaporization at higher temperatures and will enhance fuel vaporization by producing more finely divided fuel.

To improve fuel vaporization at low ambient temperatures, the disclosed PFI system may include a system for raising the temperature of fuel in a PFI fuel rail or accumulator. The temperature control system may include one or more heating elements in the PFI fuel rail. The fuel rail may also be surrounded by thermal insulation to increase the efficiency of maintaining the temperature of fuel in the PFI rail. The heating elements may be controlled by the ECU to regulate the temperature of fuel in the PFI rail according to conditions of the PFI fuel system. The temperature to which the fuel in the PFI rail is heated depends on the fuel, the atmospheric pressure and other factors. One objective of raising the temperature of the fuel is to raise the temperature above the boiling point of the fuel at atmospheric pressure. When pressurized fuel is emitted from a PFI injector, it will “flash” into vapor and mix readily with air being drawn into the engine cylinder. Vaporized fuel well-mixed with the intake air burns more completely and efficiently, leading to improved engine performance, better fuel economy, and reduced exhaust emissions.

The disclosure includes a fuel system for delivering liquid fuel to a combustion chamber of an internal combustion engine, the fuel system comprising a port fuel injector in an air intake communicating with the combustion chamber, a first fuel rail containing pressurized liquid fuel in communication with the port fuel injector, a direct fuel injector arranged to inject fuel directly into the combustion chamber, second fuel rail containing pressurized liquid fuel in communication with the direct injector, a high-pressure fuel pump having a high-pressure outlet in communication with the second fuel rail, a regulator valve in communication with the high-pressure outlet and the first fuel rail, the regulator valve controllable to reduce a fuel pressure of fuel delivered to the first fuel rail relative to a fuel pressure at said high-pressure outlet; and a control system configured with computer-readable instructions stored in non-transitory computer readable media, the instructions executable to monitor fuel pressure in the first fuel rail, and control the regulator valve to deliver fuel to the first fuel rail to maintain a predetermined quantity of fuel at said predetermined pressure in the first fuel rail.

The high-pressure fuel pump includes an inlet control valve which regulates a quantity of fuel pressurized by the high-pressure pump under the direction of the control system and in response to a sensed fuel pressure corresponding to the first fuel rail and the second fuel rail, wherein the quantity of fuel pressurized by the high-pressure pump supplies pressurized fuel to both the first and second fuel rails. The disclosed fuel system may include a heater embedded in or attached to the first fuel rail, the heater transferring thermal energy to the liquid fuel in the first fuel rail, and the control system may include instructions executable to increase a temperature of the fuel in the first fuel rail to a predetermined temperature, wherein the predetermined pressure in the first fuel rail prevents transition of the fuel to a gaseous phase within the first fuel rail, a fuel flow path from the first fuel rail to the port fuel injector or the port fuel injector at the predetermined temperature. The electrical resistance of the heater may vary with temperature and said control system may include instructions to determine a temperature of fuel in the first fuel rail by sensing the electrical resistance of the heater, and apply power to the heater to maintain the temperature of fuel in the first fuel rail at the predetermined temperature.

The first fuel rail may be insulated to contain thermal energy delivered to said fuel by the heater (if present). The predetermined pressure in the first fuel rail is between 30 bar and 80 bar. The fuel is gasoline and said predetermined temperature is below the boiling point of the fuel at said predetermined pressure.

### BRIEF DESCRIPTION OF THE DRAWINGS

FIG. 1 is a schematic diagram of a fuel system incorporating high pressure PFI and thermal management according to aspects of the disclosure;

FIG. 2 is a schematic illustration of an insulated fuel rail with heaters according to aspects of the disclosure; and

FIG. 3 illustrates an internal combustion engine equipped with a DI and PFI fuel system according to aspects of the disclosure.

### DETAILED DESCRIPTION

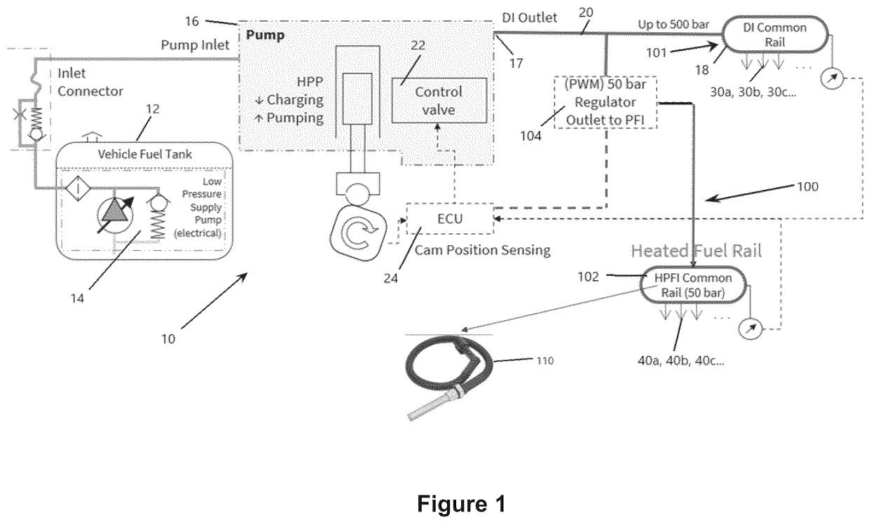

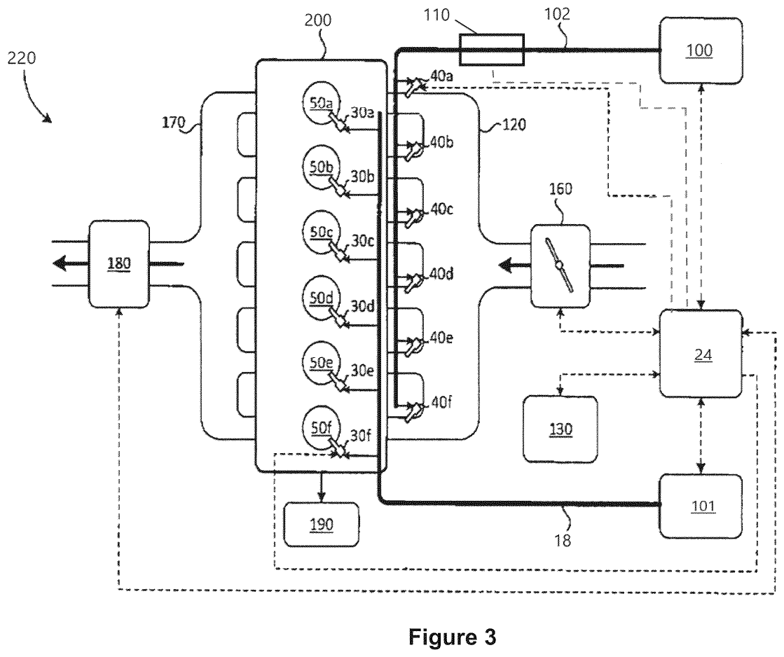

FIG. 1 illustrates a representative fuel system 10 incorporating a disclosed high-pressure port fuel injection (PFI) system 100 and a direct injection (DI) system 101. The disclosed high-pressure PFI system 101 is configured to improve emissions and engine performance, particularly in cold operating environments. The fuel system 10 includes both a direct injection (DI) system 101 to inject fuel directly into the combustion chamber of each cylinder of an internal combustion engine and a port fuel injection (PFI) system 100 to inject fuel into intake passages communicating with the engine cylinders. Fuel systems including both DI and PFI may be referred to as “dual injection” fuel systems. FIG. 3 illustrates an internal combustion engine 220 incorporating the disclosed high-pressure PFI system 100 and a DI system 101. Dual injection systems can improve emissions and performance of internal combustion engines by using PFI and/or DI according to engine operating conditions. Dual injection systems produce both improved emissions and improved performance over the full range of engine operating conditions when compared to fuel systems using only PFI or DI alone.

FIG. 3 illustrates a representative internal combustion engine system 220 including engine 200 equipped with the disclose high-pressure PFI system 100 and a DI system 101. The engine 200 is an in line six cylinder engine, but the disclosed fuel systems are compatible with any number of engine cylinders. The disclosed high-pressure PFI system 100 supplies fuel through fuel injectors 40a-40f positioned in the intake runner of the intake manifold 120 for each engine cylinder 50a-50f. The DI system supplies fuel through fuel injectors 30a-30f into the combustion chamber of each engine cylinder 50a-50f. In this description, the phrases “direct injection” and “injecting directly into the combustion chamber” are phrases that describe methods for injecting fuel into the combustion chamber without passing through the intake valve that regulates flow from the intake runner into the combustion chamber. PFI fuel injectors 40a-40f have different characteristics and specifications compared to DI fuel injectors 30a-30f, since there are different requirements for injecting fuel directly into the combustion chambers compared to injecting fuel into the intake manifold. The internal combustion engine 200 includes a throttle 160 which regulates the amount of air entering the engine through the intake manifold 120. The fuel-air mixture is ignited in the combustion chambers 50a-50f, causing the respective pistons (not shown) to reciprocate thereby imparting motive force to driveline 190 through a crankshaft (not shown). Exhaust gasses flow out of combustion chambers 50a-50f through exhaust manifold 170 to an exhaust after-treatment system 180 to control the reduction of emissions. In some internal combustion engine systems, an exhaust after-treatment system 180 may not be required. The internal combustion engine system 220 includes sensors 130 that monitor engine status and provide a plurality of signals to an engine control unit (ECU) 24. The ECU 24 can include both hardware and software components. The ECU 24 comprises a processor and memory, including one or more permanent storage devices such as FLASH, EEPROM and temporary memory such as SRAM and DRAM for storing and executing computer readable program instructions.

The ECU 24 is operatively connected to the sensors 130, throttle 160, high-pressure PFI system 100, and DI system 101. The fuel system 10 of FIG. 1 includes a fuel tank 12 equipped with a low-pressure supply pump (LPP) 14. The LPP 14 draws liquid fuel such as gasoline from the fuel tank 12 and supplies the liquid fuel to a high-pressure pump (HPP) 16, where the liquid fuel is compressed and delivered to a DI common rail 18 for injection directly into the combustion chamber 50a-50f of each engine cylinder. The HPP 16 has a DI outlet 17 and a high-pressure fuel line 20 for supplying high-pressure fuel to the DI common rail 18. The HPP 16 may be a positive displacement pump driven by a cam connected to an engine shaft as shown in FIG. 1. Alternatively, the HPP may be driven by an electric motor or other source of power. The HPP pressurizes liquid fuel to pressures between 350 bar and 500 bar (35 Mpa-50 Mpa). Construction and operation of such HPP are well-known and are not discussed in detail here. A control valve 22 is opened and closed by the ECU 24 to regulate the volume of fuel pressurized by the HPP 16 and delivered to the DI common rail 18, as is known in the art.

The LPP 14 is a motor-driven pump producing fuel pressures between 5 and 15 bar (0.5 Mpa-1.5 Mpa). In some prior art dual injection systems, fuel is supplied directly from the LPP to a PFI rail, so the PFI system is limited to operating at the relatively low fuel pressures generated by the LPP. The disclosed dual injection fuel system 10 incorporates a high-pressure port fuel injection (HPFI) system 100 and a DI system 101. In the HPFI system 100, pressurized fuel is delivered to an HPFI rail 102 by a regulating valve 104 connected to the DI outlet 17 or high-pressure fuel line 20. According to aspects of the disclosure, the HPFI rail 102 includes a heater 110 that adds thermal energy (heat) to the fuel in the HPFI rail 102. Warming the fuel in the HPFI rail 102 enhances vaporization of the fuel, especially at startup and in cold weather conditions. Pressure in the high-pressure fuel line 20 may be in the range of 350 bar to 500 bar (35 Mpa-50 Mpa) or higher. The regulating valve 104 reduces the pressure of fuel delivered to the HPFI rail 102 under control of the ECU 24. According to aspects of the disclosure, the regulating valve 104 will supply fuel to the HPFI rail 102 at pressures between 30 bar and 80 bar (3 Mpa-8 Mpa), preferably approximately 50 bar (5 Mpa). According to aspects of the disclosure, fuel pressure available at the HPFI rail 102 is between 2 and 5.3 times the fuel pressure produced by the LPP 14 and provides two significant advantages to the proposed dual injection system 10. First, high fuel pressures improve fuel atomization through PFI injectors 40a, 40b, 40c, enhancing fuel vaporization and mixing during fueling by the HPFI system 100 at low engine speeds and loads and at all operating temperatures. Second, high fuel pressures in the HPFI system 100 resist vaporization of liquid fuel within the rail, fuel lines and PFI injectors at higher temperatures, allowing the disclosed HPFI system to add thermal energy to the liquid fuel before delivery to the PFI injectors 106 to improve fuel vaporization at low operating temperatures and during engine starting. In the absence of sufficient fuel pressure in the fuel lines, HPFI rail 102 and PFI injectors 40a, 40b, 40c, increased fuel temperature can lead to vaporization of the fuel and vapor lock at the PFI injectors 40a, 40b, 40c.

The regulating valve 104 may be a PWM regulating valve, where a high-frequency on/off electrical signal controls the valve's position, regulating fluid pressure and/or flow. By precisely controlling the “on” time (pulse width) relative to the “off” time, the valve can maintain a specific average position, which in turn creates a precise pressure or flow rate. A higher duty cycle (more “on” time) allows more flow or pressure, while a lower duty cycle results in less flow or pressure. According to aspects of the disclosure, the HPP 16 produces sufficient flow of pressurized fuel to supply both the DI system 101 and the HPFI system 100. The ECU is operatively connected to sense fuel pressure in the DI rail 18 and the HPFI rail 102. The control valve 22 in the HPP 16 regulates the quantity of fuel pressurized fuel under the direction of the ECU 24 and in response to fuel pressure readings corresponding to the DI rail 18 and the HPFI rail 102.

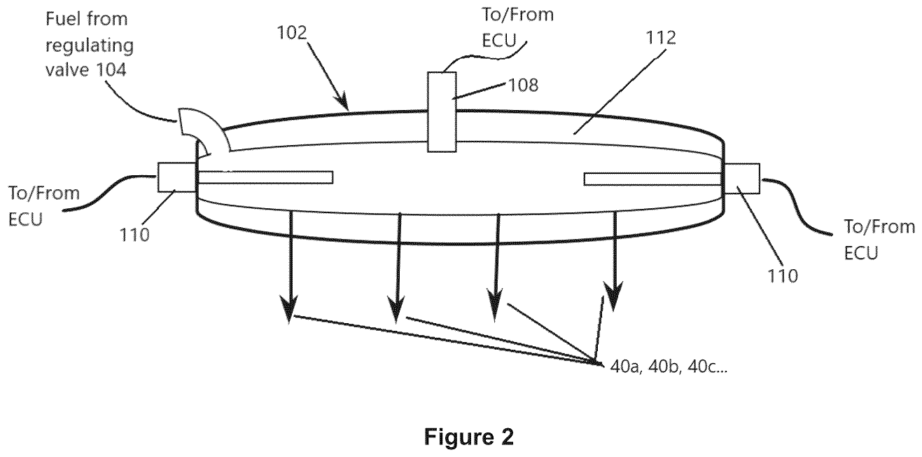

According to aspects of the disclosure, thermal energy (heat) may be added to liquid fuel in the HPFI fuel rail 102 by one or more heating elements 110 integrated with the HPFI fuel rail 102. FIG. 2 illustrates a representative HPFI fuel rail 102 with two heating elements 110 embedded within the HPFI fuel rail 102. Alternative heating element configurations can be wrapped around the HPFI fuel rail 102 as will occur to those skilled in the art. The disclosed HPFI fuel rail 102 may be surrounded by thermal insulation 112 to minimize heat loss and improve energy efficiency. The ECU 24 is in communication with a pressure sensor 108 on the HPFI fuel rail 102 and the regulating valve 104. The ECU 24 is programmed to regulate the quantity and pressure of fuel delivered to the HPFI fuel rail 102 by the regulating valve 104 and to adjust power delivered to the heating element(s) 110 (if present) based on a monitored temperature of fuel in the HPFI fuel rail 102. In one embodiment, the ECU is configured to sense a resistance of the heating element 110 and derive a temperature of fuel in the HPFI fuel rail from the sensed resistance. Other temperature sensing methods may be used.

The disclosed HPFI system 100 permits delivery of fuel to the intake of an internal combustion engine at higher pressures and/or temperatures than are possible with prior art port fuel injection systems. Higher fuel pressure and/or temperature provide enhanced fuel vaporization and reduced emissions, particularly at engine startup and in cold operating conditions.

What is claimed:

1. A fuel system for delivering liquid fuel to a combustion chamber of an internal combustion engine, the fuel system comprising:
a port fuel injector in an air intake communicating with the combustion chamber;
a first fuel rail containing pressurized liquid fuel in communication with the port fuel injector;
a direct fuel injector arranged to inject fuel directly into the combustion chamber;
a second fuel rail containing pressurized liquid fuel in communication with the direct injector;
a high-pressure fuel pump having a high-pressure outlet in communication with the second fuel rail;
a regulator valve in communication with the high-pressure outlet and the first fuel rail, said regulator valve controllable to reduce a fuel pressure of fuel delivered to the first fuel rail relative to a fuel pressure at said high-pressure outlet; and
a control system configured with computer-readable instructions stored in non-transitory computer readable media, said instructions executable to:
monitor fuel pressure in the first fuel rail; and
control the regulator valve to deliver fuel to said first fuel rail to maintain a predetermined quantity of fuel at said predetermined pressure in said first fuel rail.

2. The fuel system of claim 1, wherein the high-pressure fuel pump comprises an inlet control valve which regulates a quantity of fuel pressurized by the high-pressure pump under the direction of the control system and in response to a sensed fuel pressure corresponding to the first fuel rail and the second fuel rail, wherein the quantity of fuel pressurized by the high-pressure pump supplies pressurized fuel to both the first and second fuel rails.

3. The fuel system of claim 1, comprising a heater embedded in or attached to the first fuel rail, said heater transferring thermal energy to the liquid fuel in the first fuel rail, and said instructions are executable to:
increase a temperature of the fuel in the first fuel rail to a predetermined temperature, wherein said predetermined pressure prevents transition of the fuel to a gaseous phase within the first fuel rail, a fuel flow path from the first fuel rail to the port fuel injector or the port fuel injector at said predetermined temperature.

4. The fuel system of claim 2, wherein an electrical resistance of the heater varies with temperature and said control system includes instructions to:
determine a temperature of fuel in the first fuel rail by sensing the electrical resistance of the heater; and
apply power to the heater to maintain the temperature of fuel in the first fuel rail at said predetermined temperature.

5. The fuel system of claim 2, wherein said fuel rail is insulated to contain thermal energy delivered to said fuel by said heater.

6. The fuel system of claim 1, wherein said predetermined pressure is between 30 bar and 80 bar.

7. The fuel system of claim 2, wherein the fuel is gasoline and said predetermined temperature is below the boiling point of the fuel at said predetermined pressure.
